(19) United States
(12) Patent Application Publication
(10) Pub. No.: US 2019/0350430 A1
(43) Pub. Date: Nov. 21, 2019

(54) STACK OF SHEETS WITH ADHESIVE BACKING FOR LINT REMOVAL

(71) Applicant: H&H, LLC, Milford, OH (US)

(72) Inventor: Mark S. Hartwell, Milford, OH (US)

(21) Appl. No.: 16/412,470

(22) Filed: May 15, 2019

Related U.S. Application Data
(60) Provisional application No. 62/672,229, filed on May 16, 2018.

(51) Int. Cl. A47L 13/18; B08B 7/00; A47L 25/00

(52) U.S. Cl. CPC A47L 13/18; A47L 25/005; B08B 7/0028

(57) ABSTRACT

A stack of lint removing sheets suitable for use in removing lint from clothing includes a plurality of sheets stacked on top of one another, with each sheet including an adhesively-backed surface and a non-adhesively backed surface. Each sheet, when part of the stack of sheets, has its adhesively-backed surface against the non-adhesively backed surface of another sheet. Each sheet includes a strip that, when the sheet is removed from the stack of sheets, forms a passageway with the rest of the sheet into which a user's hand can be inserted. The strip of each sheet does not have an adhesively-backed surface.

### CROSS REFERENCE TO RELATED APPLICATION

The present application claims the filing benefits of U.S. provisional application Ser. No. 62/672,229, filed May 16, 2018, which is hereby incorporated herein by reference in its entirety.

### FIELD OF THE INVENTION

The present invention relates generally to lint removal elements that are used to remove lint from clothing.

### BACKGROUND OF THE INVENTION

It is known to remove lint from clothing using a roller with a rolled up sheet of adhesive-backed material, whereby a user may tear off sections of the rolled up sheet to expose not yet used material. The rollers have a handle and are bulky and not easily carried.

### SUMMARY OF THE INVENTION

The present invention provides a stack of adhesive-backed lint removal sheets or packs that can be removed from the stack and used to remove lint from clothing. Each sheet includes a slot or opening that allows a user to insert their fingers or hand therein to hold the single sheet (when removed from the stack of sheets) during use. The sheets have an adhesive backing to retain the sheets on the next lower sheet of the stack and to remove lint from clothing during use of the removed sheet. The portion of the sheet that provides the slot or opening or “handle” may be devoid of the adhesive backing so as to not adhere to the person's fingers or hand during use.

These and other objects, advantages, purposes and features of the present invention will become apparent upon review of the following specification in conjunction with the drawings.

### BRIEF DESCRIPTION OF THE DRAWINGS

FIG. 1 is a perspective view of a stack of lint removing sheets in accordance with the present invention;

FIG. 2 is another perspective view of the stack of lint removing sheets of FIG. 1, shown with a top sheet partially removed from the stack;

FIGS. 3 and 4 are perspective views of a removed sheet, shown with a user's hand inserted into or through a sleeve or handle of the sheet;

FIG. 5 is another perspective view of the removed sheet, shown during use of the sheet to remove lint from clothing; and

FIG. 6 is an enlarged perspective view of the stack of sheets, showing rounded cutouts at the end of each slit along the handle portion.

### DESCRIPTION OF THE PREFERRED EMBODIMENTS

Referring now to the drawings and the illustrative embodiments depicted therein, a stack of lint removing sheets 10 comprises a plurality of sheets or pads 12 (e.g., flexible paper sheets or coated paper sheets or the like) stacked on top of one another and adhesively attached together. The sheets have an adhesive back side or surface 12a and a non-adhesive top side or surface 12b, and include a handle portion 14 that is configured for a user's had to partially be received thereat to assist the user in holding the sheet during use of the sheet in removing lint from clothing. The handle portion 14 is formed by cutting or establishing slits 16 along either side of the handle portion, with the slits spanning partially across a width dimension of the sheets.

The adhesive backing on the back side 12a of each sheet functions to retain the respective sheet to the top side 12b of the next sheet of the stack of sheets (such as a stack of 20 sheets or 50 sheets or 100 sheets or more). When a sheet is to be used, a user can readily peel the top-most sheet from the stack of sheets (see FIG. 2), such that the adhesive-backed back side 12a is exposed. The adhesive and sheet material are selected so that the adhesive retains the sheets together, but readily allows for peeling of one sheet from another without damaging the top side of the other sheet and without leaving adhesive residue at the top side of the other sheet. The bottom sheet may be adhered to a non-adhesively backed backing sheet (that does not have adhesive on either side) so the stack of sheets may be set on a surface and not adhere to the surface).

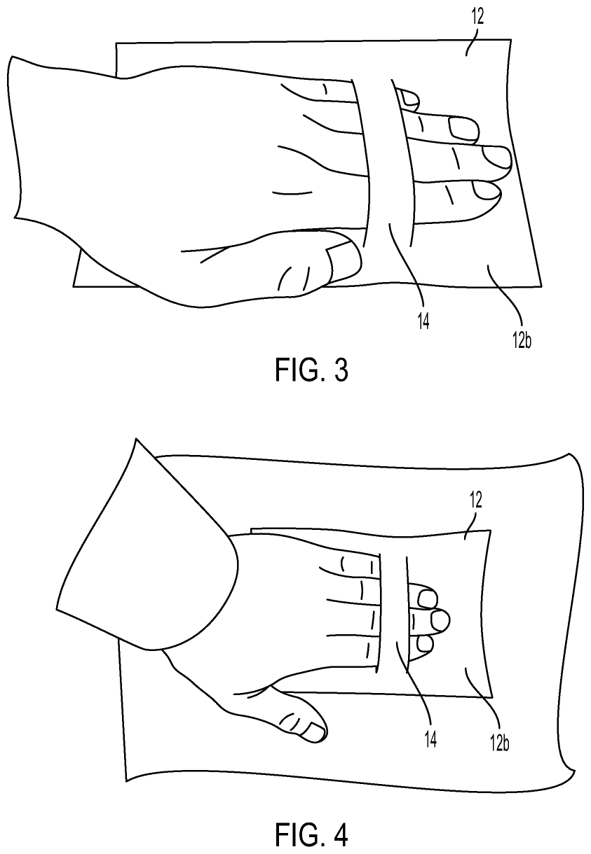

The sheets each have a cut-out strip or handle portion 14 that, when the sheets are adhered together in the stack, is flat and co-planar with the respective sheet. When a sheet is removed from the stack for use, the strip 14 can be flexed in one direction and the rest of the sheet can be flexed in the opposite direction, so that a loop or passageway is formed to receive the user's hand partially therein (see FIGS. 3-5). The strip 14 of each sheet 12 is preferably devoid of adhesive on the back or bottom side or surface, so that the strip does not adhere to the user's hand during use of the sheet to remove lint. The strip of each sheet extends partially across a width dimension of the respective sheet, such that part of the adhesively-backed surface of the sheet circumscribes the strip and provides a lint-removing surface that is substantially the entirety of the back side or surface of the sheet, with only the back side or surface of the strip being devoid of adhesive.

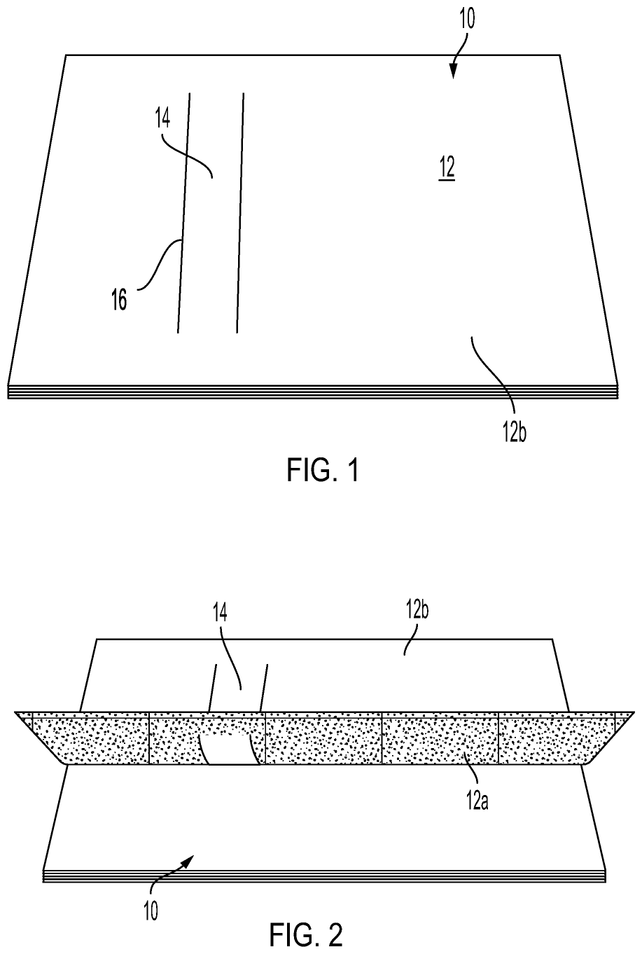

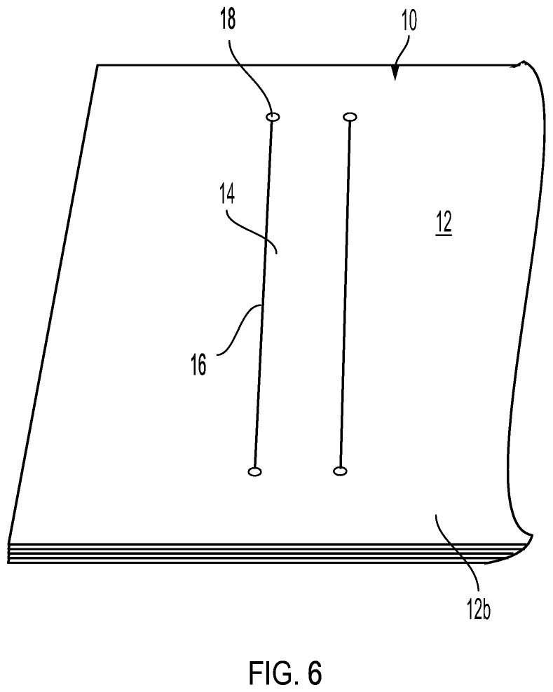

The handle portion 14 is formed via a pair of slits 16 made through the sheet 12 and extending partially across the width dimension of the sheet. The slits 16 may be of the same length and may be parallel to one another, such as shown in FIG. 1. As best shown in FIG. 6, the slits 16 may have a radiused end, such as via a circular or oval or rounded aperture 18 formed at each of the ends of each of the slits, to limit tearing of the sheets during use. The slits 16 thus may be cut or established along the sheet between two respective holes or apertures 18 punched through the sheet 12. The slits may be fully cut slits or may be perforated so that the handle portion is partially attached along the sheet until a user uses the sheet (whereby the user tears along the perforations to use the sheet after the sheet is removed from the stack of sheets).

Optionally, it is envisioned that the sheets may be formed with the strip also having an adhesive back surface, such that the entire sheet has adhesive on its back surface. Optionally, a small perimeter region of each of the sheets (such as a corner region of rectangular-shaped sheets) may be devoid of adhesive at its back side or surface so as to ease removal or peeling of the sheets from one another. In such an application, the user may readily grasp the non-adhesively backed corner or perimeter region of a sheet and peel the top sheet from the stack of sheets.

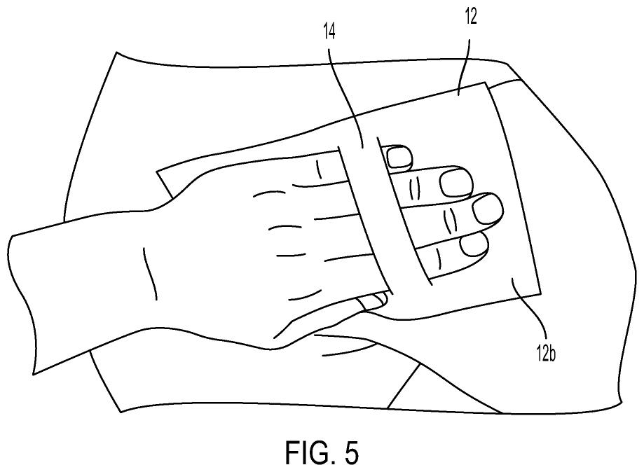

Thus, a user can readily peel and remove a sheet from the stack of sheets and insert their hand into the passageway formed by the sheet and the handle portion or strip so that the user can hold the sheet during use (see FIG. 5) when removing lint from clothing. When done with that sheet, the used sheet can be disposed of, while the rest of the sheets remain in the stack. The stack is compact and flat and can be easily stored in a purse or brief case or carrying bag, whereby the user can pull out the stack and remove one sheet from the top of the stack for use. The sheets can be cut or formed in any suitable or desired shape, such as rectangular shaped (as shown in FIGS. 1-6) or any other shape, such as oval or hand-shaped or the like.

The stack of sheets may be formed via any suitable process. For example, the sheets may be formed with an adhesive on one side and no adhesive on the other side, with the adhesive side having a strip or surface that is devoid of the adhesive. The sheets may be stacked on top of one another, with the adhesive side of each sheet being at and adhering to the non-adhesive side of the next adjacent sheet. The strip or handle portion is formed by cutting or punching or otherwise establishing slits (and radiused or rounded apertures at the ends of the slits) at and along each side of the non-adhesively backed strip. The slits may be formed before or after stacking the sheets, but preferably after stacking so the entire stack of sheets may be cut or punched to the desired shape and have the slits formed therethrough via a common process.

In use, a user can peel a top most sheet from the stack of sheets and insert his or her hand into the handle portion formed by the slits, with the non-adhesive side of the sheet being against the palm of the user's hand and with the non-adhesively backed strip being at the opposite side of the user's hand. The user can then press the adhesive surface of the sheet against an article of clothing or the like to remove lint from the article via the adhesive surface of the sheet.

Changes and modifications in the specifically described embodiments can be carried out without departing from the principles of the invention, which is intended to be limited only by the scope of the appended claims, as interpreted according to the principles of patent law including the doctrine of equivalents.

1. A stack of lint removing sheets suitable for use in removing lint from clothing, said stack of sheets comprising:
a plurality of sheets stacked on top of one another;
wherein each sheet of the plurality of sheets comprises an adhesive surface on one side of the sheet and a non-adhesive surface on the other side of the sheet, and wherein each sheet, when the sheets are stacked on top of one another, has its adhesive surface against the non-adhesive surface of another sheet;
wherein each sheet comprises a strip that, when the sheet is removed from the stack of sheets, forms a passageway with the rest of that sheet into which a user's hand can be inserted; and
wherein the strip of each sheet does not have an adhesive surface on either side.

2. The stack of sheets of claim 1, wherein the strip of each sheet extends partially across a width dimension of the respective sheet, such that the adhesive surface on the one side of the sheet circumscribes the strip.

3. The stack of sheets of claim 1, wherein a perimeter region of each sheet does not have an adhesive surface on either side to ease removal of the sheets from the stack of sheets.

4. The stack of sheets of claim 3, wherein the perimeter region at least partially circumscribes the adhesive surface on the one side of the sheet.

5. The stack of sheets of claim 3, wherein the perimeter region comprises a corner region of the sheet.

6. The stack of sheets of claim 1, wherein the strip is formed via two slits made in the respective sheet.

7. The stack of sheets of claim 6, wherein the slits are parallel.

8. The stack of sheets of claim 6, wherein the slits are the same length.

9. The stack of sheets of claim 8, wherein the slits span part of and less than the entirety of a width dimension of the respective sheet.

10. The stack of sheets of claim 6, comprising a rounded aperture formed at each end of each slit of the respective sheet.

11. A method of making and using lint removing sheets, said method comprising:
providing a plurality of sheets, each having an adhesive surface on one side of the sheet and a non-adhesive surface on the other side of the sheet, wherein the one side has a strip that does not have the adhesive surface;
stacking the sheets on top of one another with the adhesive surface of each sheet being against and adhered to the non-adhesive surface of another sheet;
forming two slits that extend partially across the sheet and along longitudinal sides of the strip to form a handle portion of the sheet;
removing a sheet from the top of the stack of sheets by peeling a top most sheet from the top of the stack of sheets; and
inserting a user's hand into the handle portion and pressing the adhesive surface against an article to remove lint from the article.

12. The method of claim 11, wherein the strip on the one side of the sheet is circumscribed by the adhesive surface on that side.

13. The method of claim 11, wherein stacking the sheets is done before forming the two slits.

14. The method of claim 11, wherein stacking the sheets is done after forming the two slits.

15. The method of claim 11, comprising forming a rounded aperture through each sheet at each end of each of the slits.

16. The method of claim 11, wherein the slits are parallel.

17. The method of claim 11, wherein the slits are the same length.

18. The method of claim 17, wherein the slits span part of and less than the entirety of a width dimension of the respective sheet.

19. The method of claim 11, wherein a perimeter region of each sheet does not have an adhesive surface on either side to ease removal of the sheets from the stack of sheets.

20. The method of claim 19, wherein the perimeter region comprises a corner region of the sheet.
